(19) United States
(12) Patent Application Publication
(10) Pub. No.: US 2013/0118600 A1
(43) Pub. Date: May 16, 2013

(54) Reversible Method of Converting Self-Draining Agricultural Irrigation Pipe for Non-Leaking Use in Intermittent Pump Applications and Method of Use

(71) Applicant: Tom Truitt, Mesquite, TX (US)

(72) Inventor: Tom Truitt, Mesquite, TX (US)

(21) Appl. No.: 13/733,116

(22) Filed: Jan. 2, 2013

(51) Int. Cl. F17D 1/00; B23P 17/00

(52) U.S. Cl. CPC F17D 1/00; B23P 17/00
USPC 137/15.01; 29/401.1

(57) ABSTRACT

The present invention provides a reversible method of modifying standard self-draining agricultural irrigation pipe for non-leaking use in intermittent pump applications. The present invention also provides a method of using this modified pipe to provide and distribute water and other fluids for use in the process of hydraulically fracturing various wells drilled to produce petroleum and related products, particularly natural gas wells.

### CROSS-REFERENCE TO RELATED APPLICATIONS

This application claims benefit of U.S. Provisional App. No. 61/679735 filed Aug. 5, 2012 which is incorporated in its entirety by reference.

### FIELD OF THE INVENTION

The present invention relates to a method of reversibly converting conventional, self-draining agricultural irrigation pipe for use in applications in which self-draining operation is unacceptable. The present invention also relates to a method of using such converted pipe for the distribution of fluid used in petroleum exploration and production operations, particularly hydraulic fracturing operations.

### BACKGROUND OF THE INVENTION

The recent ascendancy of hydraulic fracturing as a method for extracting hydrocarbon products—particularly shale gas—trapped in otherwise inaccessible rock strata has radically changed the process of hydrocarbon production. While hydraulic fracturing utilizes many different types of fracturing fluids with additives such as acids, emulsifiers, gels, surfactants, and proppants such as particles of sand, ceramic, glass, and sintered bauxite, the most common ingredient is copious amounts of water. Most wells require 1.0 to 3.5 million U.S. gallons of water to suitably fracture with some requiring as much as 5.0 million U.S. gallons. This is in addition to the millions of U.S. gallons of water necessary to merely drill the well. This requirement for large amounts of localized water is even greater considering that as many as sixteen vertical or four horizontal wells may be drilled per square mile of gas field. Finally, there is the issue of what to do with the water recovered from the well after the fracturing process.

Unsurprisingly, sufficient water to fracture a gas well is often not available on site. With much hydraulic fracturing being conducted in relatively dry geographic areas such as the Bakken Shale of North Dakota, the Barnett Shale of North Texas, the Marcellus Shale of Pennsylvania, and the Raton Basin of Colorado, this is not surprising. Moreover, environmental restrictions may dictate that water be collected at some distant point. In either case, sufficient water to hydraulically fracture a well usually must be transported to the proximity of the well, most often by means of truck or temporary pipeline. Unfortunately, delivery by truck is often not an option in situations in which roads are non-existent and impractical or poorly constructed.

Temporary water delivery pipelines are usually constructed of polyvinylchloride (PVC) plastic, but conventional agricultural irrigation pipe is also used. Agricultural irrigation pipe is more durable and arguably more environmentally friendly than PVC, but conventional agricultural irrigation pipe has a major flaw when used for this purpose. Specifically, agricultural irrigation pipe is designed to drain when the line is shut off and the pressure released. Various “chevron” shaped gaskets are available that alter the rate at which the pipes drain, however. Generally, these fall into two classes: “drain” gaskets which begin draining with a relatively small drop in pressure and “non-drain” gaskets which leak water at substantially lower pressures. In agricultural settings, such drainage is usually advantageous because it makes it easier to manipulate the pipes and move them to another location. This is a major disadvantage when transporting water for hydraulic fracturing purposes because water to be delivered to the well is not pumped continuously. Rather, water must be pumped intermittently and stored on site in a tank or temporary storage pond. As a result, when using agricultural irrigation pipeline to deliver water and the pumps are turned off, the water in the line leaks out. This causes at least two major problems: First, there is significant water loss. For example, two 10″ diameter pipelines extending five miles contain over 200,000 U.S. gallons of water. Every time the well-site storage tanks are filled and pumping ceases, all 200,000 U.S. gallons may leak out. Over time, millions of gallons of water may be wasted. Second, since the temporary lines necessary to deliver water to the well invariably cross property owned by multiple land owners, and since some of those land owners will have tremendous sensitivity to the idea of transported water being periodically deposited on their property, a truly non-leaking distribution system is clearly preferable.

An additional complication occurs because water used for fracturing purposes cannot be recycled for human or animal use or used in agricultural applications. As a result, such water is usually transported to disposal wells for reinjection in abandoned and non-producing strata. Such water may, however, be cleaned sufficiently to be used to fracture one or more additional wells. Ordinarily, this too is done by trucks or temporary pipeline. In this case however, the use of conventional agricultural irrigation pipeline with self-draining gaskets is not possible due to the toxic nature of the water. Thus a truly non-leaking system to redistribute this water is required.

Of course, self-draining agricultural irrigation pipe is constructed of aluminum and is very long-lived and durable. Such pipe segments may be used for decades. As a result, such pipe pressed into service as a non-leaking distribution line for hydraulic fracturing water would ideally be easily repurposed for its original self-draining agricultural use. Thus, there is a need for a reversible means of converting self-draining, agricultural irrigation pipe for use in non-leaking, intermittent pump applications, specifically for the distribution of water for hydraulic fracturing purposes and then retasking it for conventional agricultural irrigation obligations.

Associated with this reversible means of converting self-draining, agricultural irrigation pipe for use in non-leaking, intermittent pump applications, a means of employing such pipe in hydraulic fracturing applications is needed.

### BRIEF DESCRIPTION OF THE DRAWINGS

FIG. 1 is a cross section diagram of the pipe-bell union between two lengths of standard aluminum agricultural irrigation pipeline with a standard drain gasket.

FIG. 2 is a cross section diagram of the pipe-bell union between two lengths of modified aluminum agricultural irrigation pipeline in accordance with the present invention.

FIG. 3 is a diagram showing a typical installation servicing a natural gas fracturing well-head illustrating a method of utilizing the present invention.

### BRIEF SUMMARY OF THE INVENTION

Generally, the present invention provides a reversible method of modifying standard agricultural irrigation pipe for non-leaking use in intermittent pump applications and a method of distributing water and other fluids using this modified pipe. The steps of modifying standard agricultural irrigation pipe for non-leaking use in intermittent pump applications include: 1) Removing the “square” or “round” back chevron gasket installed in the circumferential annular groove molded or otherwise formed on the inside aspect of the female coupling of a length of agricultural irrigation pipe; 2) Drilling or machining a hole ranging from approximately ¼″ to ½″ in diameter, preferably about ⅜″ in diameter, from the outside surface of the pipe to the inside surface of the lumen of the pipe along a radial line extending outward from the linear central axis of the pipe such that the hole passes through a point along the circumferential line dividing the circumferential annular groove into two equal halves; 3) Inserting a circular tubular gasket with an air retaining inflation valve such as a Schrader valve extending radially out and away from the center point of the circular gasket such that when the tubular gasket is inserted into the circumferential annular groove the air retaining inflation valve extends through the hole drilled or machined into the pipe and the terminal aspect of the air retaining inflation valve.

In use, the pipes are connected end-to-end and the tubular gasket is inflated in each joint as adjoining pipes are locked together. This process continues until one or more pipes of sufficient length extend from the fluid source to the fluid storage facility. The user may then pump fluid from the source to the storage facility and experience little or no fluid loss from the joints in the line when the pump is periodically deactivated and the pressure in the line falls.

To reverse the modification procedure, the user merely removes the tubular gasket and replaces it with the original “square back” or “round back” chevron gasket when the pipe or pipes are disassembled.

### DETAILED DESCRIPTION OF THE INVENTION

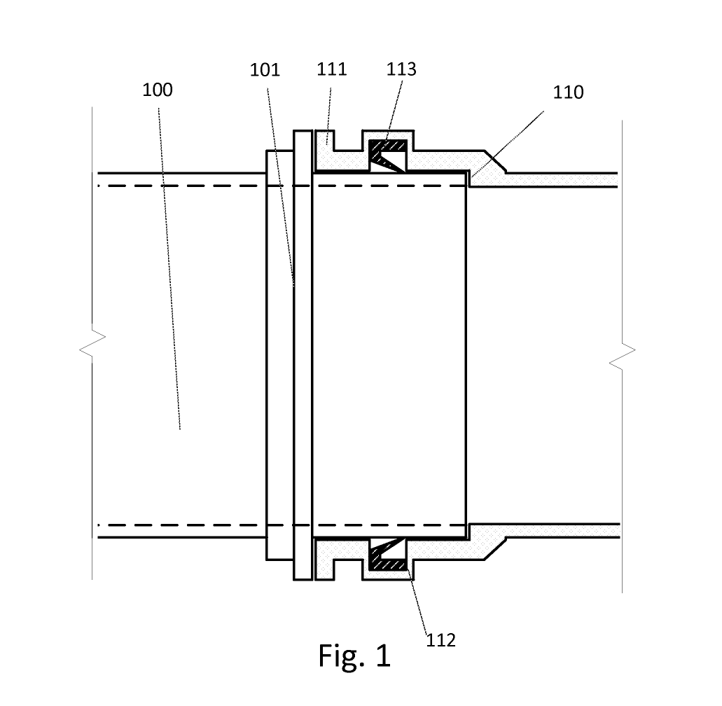

Turning now to FIG. 1, agricultural irrigation pipe is usually constructed of aluminum or steel tubing and comes in a variety of styles with a wide variety of coupling systems. The most common locking mechanisms for the most common coupling systems are: 1) A cam actuated “circle lock” or “ring lock” or similar locking band that circumferentially surrounds and captures two juxtaposed circumferential flanges 101 and 111 welded or formed on opposite ends of two pieces of agricultural irrigation pipe 100 and 110, respectively, when they are coupled together; or, 2) A “band and latch” coupling bolted or welded onto the male end of one piece of agricultural irrigation pipe such that when coupled to the female end of a second, adjoining pipe, the latch snaps into, or over, a latch retaining cavity or catch in the adjoining pipe. In all cases however, the interior aspect of the female coupling is provided with a circumferential groove 112 allowing for the installation of a sealing gasket. This circumferential groove 112 may be formed generally in a rectangular or square cross section (as shown) allowing for the installation of a “square back” chevron gasket 113 or it may be formed with a generally semi-circular cross section allowing for the installation of a “round back” chevron gasket. In this example, the “square back” chevron gasket 113 is installed such that its sealing lip protrudes up slightly into the lumen of the pipe, such that when the male end of pipe 100 is inserted, the lip of “square back” chevron gasket 113 circumferentially surrounds the male end of pipe 100. “Square back” chevron gasket 113 is installed such that when the line is pressurized, its sealing lip is pressed tightly against the coupled pipe 100. When the pressure in the pipe is released, the sealing lip returns to its original shape and the fluid leaks out at a rate determined by whether a “draining” or “non-draining” chevron gasket was installed.

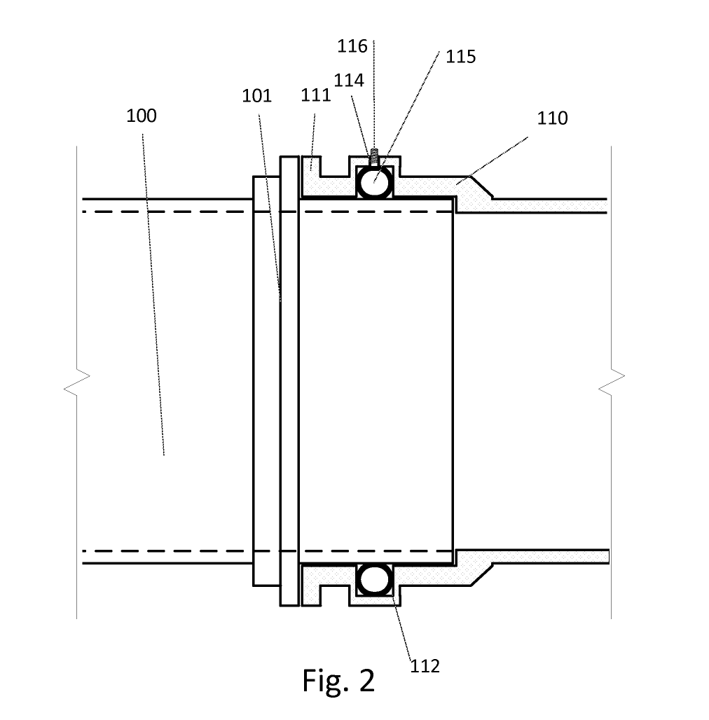

Turning now to FIG. 2, a length of agricultural irrigation pipe with a “circle lock” or “ring lock” coupling system has been modified in accordance with the teachings of the present invention. A cam actuated “circle lock” or “ring lock” circumferentially surrounds and captures two juxtaposed circumferential flanges 101 and 111 welded or formed on opposite ends of two pieces of agricultural irrigation pipe 100 and 110 when coupled together. As above, the interior aspect of the female coupling is provided with a circumferential groove 112. This circumferential groove 112 may be formed generally in a rectangular or square cross section (as shown) allowing for the installation of a “square back” chevron gasket or it may be formed with a generally semi-circular cross section allowing for the installation of a “round back” chevron gasket. In this example of a modified piece of pipe, the “square back” chevron gasket is first removed. Next, hole 114 ranging from approximately ¼″ to ½″ in diameter, preferably about ⅜″ in diameter, is drilled from the outside surface to the inside surface of agricultural irrigation pipe 110 along a radial line extending outward from the linear central axis of agricultural irrigation pipe 110 such that hole 114 passes through a point along the circumferential line dividing circumferential annular groove 112 into two equal halves. Next, an appropriately sized circular tubular gasket 115 with an air retaining inflation valve such as a Schrader valve 116 is installed in circumferential annular groove 112 in lieu of the “square back” chevron gasket. When installed properly, the air retaining inflation valve such as a

Schrader valve 116 protrudes through hole 114.

When modified in accordance with the teachings of the present invention, the male end of agricultural irrigation pipe 100 is inserted into coupling female end of agricultural irrigation pipe 110 so that a cam actuated “circle lock” or “ring lock” may be actuated to circumferentially surround and capture juxtaposed circumferential flanges 101 and 111 welded or formed on opposite ends of the two pieces of agricultural irrigation pipe 100 and 110. After agricultural irrigation pipes 100 and 110 are coupled together, compressed air is used to fill tubular gasket 115 so that it expands and substantially fills circumferential groove 112 sealing the outside surface of the male end of agricultural irrigation pipe 100 to the inner surface of circumferential groove 112 molded or otherwise formed in the female coupling end of agricultural irrigation pipe 110. By this means, a positive fluid-tight seal is achieved between agricultural irrigation pipes 100 and 110.

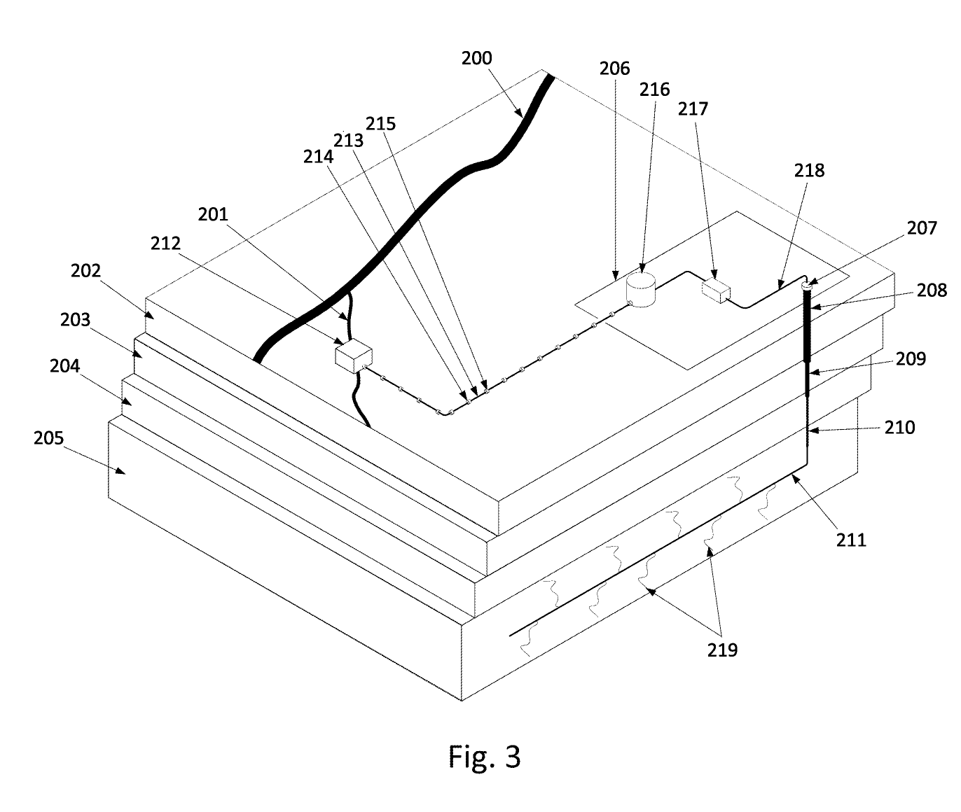

Turning now to FIG. 3, river 200 with tributary 201 is located at some distance from well-site 206. The strata in the area comprise a shallow aquifer 202, a deeper aquifer 203, a water-impervious aquiclude or aquifuge 204, and a gas bearing shale layer 205. A completed gas well with well-head 207 sits atop a three successively smaller casing strings 208, 209, and 210, respectively. The well features a directionally drilled terminal bore 211 that penetrates horizontally through the gas bearing shale layer. In a well such as this, natural gas is trapped in shale layer 205 and little naturally flows through the completed bore to well head 207. To liberate and recover this trapped gas, hydraulic fracturing is required. To fracture this well, water from tributary 201 is pumped through a pipeline comprised of a multiplicity of segments of agricultural irrigation pipe 213 modified in accordance with the present invention. Each segment of agricultural irrigation pipe 213 (typical) has a male coupling end 214 (typical) inserted in the female coupling end of the preceding segment of agricultural irrigation pipe and a modified female coupling end 215 (typical) with inflatable tubular gasket receiving the male end of the succeeding pipe. When constructed this way, and with all tubular gaskets inflated, the resulting pipeline is essentially leak-free. Water is then intermittently pumped via pump 212 to storage tank 216. Water in storage tank 216 is pumped under high pressure by fracturing pump 217 through transfer pipe 218 to well head 207, through casing strings 208, 209, and 210, and then into terminal bore 211 causing cracks 219 in the shale. After fracturing, the well is dewatered with the fracturing fluid pumped back to the surface and deposited in plastic-lined waste ponds. The now empty cracks 219 allow natural gas trapped in shale 205 to flow to terminal bore 211 where it may be recovered at the well head.

After the fracturing process is completed, the multiplicity of segments of agricultural irrigation pipe 213 (typical) may be deployed elsewhere for use in another fracturing operation. Alternately, after the fracturing process is completed and the well is dewatered, the multiplicity of segments of agricultural irrigation pipe 213 (typical) may be reoriented to transport the now used fracturing water deposited in the plastic-lined waste ponds to another well site where it may be used again, and/or to a disposal well.

Referring again to FIGS. 1 and 2, alternately each segment of agricultural irrigation pipe may be modified for use in conventional agricultural applications by removing tubular gasket 115 and replacing it with a conventional draining or non-draining chevron gasket 113, or equivalent.

The present invention is presented in what is considered to be the most practical implementation of the system and method. Nevertheless, minor variations are readily discernible to those having skill in the art. For example, tubular gasket 115 may be constructed of many types of materials including: nitrile rubber, buna-N rubber, butyl rubber, Viton®, Santoprene®, EDPM rubber, neoprene rubber, and natural rubber. Similarly, while aluminum constitutes the most commonly used material for constructing self-draining agricultural irrigation pipeline, the method of the present invention may be practiced with self-draining agricultural pipeline constructed of any material. All such variations are intended to be included within the spirit and scope of this disclosure.

What is claimed is:

1. A reversible method of converting self-draining agricultural irrigation pipe for non-leaking use comprising the following steps:
a) Removing the rubber gasket ordinarily installed in the circumferential annular groove machined or formed inside the female coupling end of a length of agricultural irrigation pipe;
b) Drilling a hole about ⅜″ in diameter from the outside to the inside surface of said agricultural irrigation pipe along a radial line extending outward from the linear central axis of said agricultural irrigation pipe such that said hole passes through a point along the circumferential line dividing said circumferential annular groove into two equal halves;
c) Installing an appropriately sized circular tubular gasket with air retaining inflation valve extending radially outward into said circumferential annual groove such that said air retaining inflation valve extends through said hole.

2. A reversible method of converting self-draining agricultural irrigation pipe for non-leaking use of claim 1 wherein said air retaining inflation valve is a Schrader valve.

3. A reversible method of converting self-draining agricultural irrigation pipe for non-leaking use of claim 1 wherein said air retaining inflation valve is a Presta valve.

4. A reversible method of converting self-draining agricultural irrigation pipe for non-leaking use of claim 1 wherein said air retaining inflation valve is a Dunlop valve.

5. A method of using the converted self-draining agricultural irrigation pipe of claim 1 to distribute intermittently pumped fluid comprising the following steps:
a) Inserting the male coupling end of a first length of converted self-draining agricultural irrigation pipe into the female coupling end of a second length of converted agricultural irrigation pipe such that the circumferential flanges present on the coupled ends of said first and second lengths of agricultural irrigation pipe are juxtaposed in close proximity;
b) Placing a locking band circumferentially around said circumferential flanges;
c) Actuating said locking band such that it substantially couples said first and second lengths of agricultural irrigation pipe together;
d) Inflating said circular tubular gasket with air retaining inflation valve extending radially outward through said hole with compressed air;
e) Repeating the foregoing steps until a transmission pipe of sufficient length is constructed;
f) Intermittently pumping fluid from a source at one end of said transmission pipe to a storage facility at the opposite end of said transmission pipe.
